(19) United States
(12) Patent Application Publication
(10) Pub. No.: US 2005/0110879 A1
(43) Pub. Date: May 26, 2005

(54) Image taking apparatus, image processing apparatus, and image processing program

(75) Inventors: Rieko Izume, Sakai-shi (JP); Noriyuki Okisu, Osakasayama-shi (JP); Motohiro Nakanishi, Kobe-shi (JP); Takehisa Yamaguchi, Ikoma-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA CAMERA, INC.

(21) Appl. No.: 10/778,467

(22) Filed: Feb. 13, 2004

(30) Foreign Application Priority Data
Nov. 25, 2003 (JP) 2003-393463

(51) Int. Cl. H04N 5/76

(52) U.S. Cl. 348/231.2

(57) ABSTRACT

An image processing apparatus permits easy changing of the file name of an image file created by an image taking apparatus. A personal computer serving as the image processing apparatus is fed with an image file created by a digital camera, and replaces a first character string included in the file name of the image file with a second character string. The first character string consists only of characters usable in a file name on the digital camera, and the second character string consists of characters selected among all the characters usable on the personal computer. The first and second character strings are entered via a keyboard, and are stored, in the form of a look-up table that lists their correspondence, in a hard disk.

This application is based on Japanese Patent Application No. 2003-393463 filed on Nov. 25, 2003, the contents of which are hereby incorporated by reference.

### BACKGROUND OF THE INVENTION

1. Field of the Invention

The present invention relates to an image taking apparatus for sensing an image and then recording it in an image file, and also relates to an image processing apparatus for processing an image recorded in an image file. More particularly, the present invention relates to a method of renaming an image file, renaming an image folder in which image files are stored, and deleting an image file or image folder.

2. Description of the Prior Art

In a digital camera, an image is sensed by means of a photoelectric conversion device, of which the output signal is then subjected to predetermined processing to generate image data representing the sensed image. Then a file is created in which to store the thus generated image data. Such files having image data stored in them are called image files, and are created one for each image. The digital camera creates image files in a format that conforms to the standard called DCF (design rule for digital camera file system), and give them file names each consisting of a string of characters that conforms to that standard.

According to the DCF standard, a file name consists of a four-character head portion and a four-character tail portion. The head portion must consist only of alphabetic (“A” to “Z”) and underscore (“_”) characters, and the tail portion must consist only of numeric characters (“0” to “9”). The head portion can be set by the user. If the user does not set the head portion, a predetermined string of characters, for example “PICT,” is used as the head portion. The numeric characters in the tail portion are set by the digital camera so that different image files, of which the file names include the same string as their head portion, are given unique, serial numbers. A file name is followed by an extension, which indicates the file format.

For easy management of image files, image files are stored in a predetermined folder as soon as they are created. Such a folder in which image files are stored is called an image folder. The user can create a new image folder with a desired folder name, and use it as the predetermined image folder in which to store the image files that will be created thereafter.

Image folders also are given folder names that conform to the DCF standard. A folder name consists of a three-character head portion and a five-character tail portion. The head portion must consist only of numeric characters (“0” to “9”), and the tail portion must consist only of alphanumeric (“A” to “Z” and “0” to “9”) and underscore (“_”) characters. When a new image folder is created, the user is permitted to set the tail portion of its folder name. When the user does not set the tail portion, a predetermined string of characters, for example “MLT01,” is used as the tail portion. The numerical characters in the head portion are set by the digital camera so that different folders, of which the folder names include the same string as their tail portion, are given unique, serial numbers. A folder name is not followed by any extension.

It is nowadays common to use a personal computer to read image files created by a digital camera for the purpose of reproducing or editing the images. It is also common to generate images on a personal computer and create image files in which the image data representing the thus generated images is recorded. Image files can be transferred from a digital camera to a personal computer either individually on a file-by-file basis or collectively on a folder-by-folder basis.

In personal computers, certain restrictions are imposed on the length of a file name or folder name and on the characters that can be used in a file name or folder name. However, the restrictions on file names and folder names here are far laxer than in digital cameras. For example, in personal computers, it is permitted to use a string consisting of three or less characters or nine or more characters as a file name or folder name, or to use kanji characters (Japanese-adapted Chinese characters) in a file name or folder name.

Moreover, in personal computers, file names and folder names can be changed (i.e., files and folders can be renamed). For example, the user can change the file names of image files created by a digital camera to those which help to easily recognize the contents of the image files. In digital cameras, the head portion of the file name of an image file and the tail portion of the folder name of an image folder can be changed, but, as described above, strict restrictions are imposed on the number and type of characters that can be used in a file or folder name.

In personal computers, files and folders can be deleted. However, if arbitrary deletion of any file or folder is permitted, there is a risk of an important file being lost as a result of the user's mistaken operation. In particular, if a folder is deleted by mistake, all the files stored in it are deleted, and accordingly there is a high risk of important files being lost. To avoid this, certain restrictions are usually imposed on deletion of files and folders.

For example, Japanese Patent Application Laid-Open No. H5-81113 proposes putting a key word to a file that should not be deleted so that deletion of the file is permitted only when the correct key word is entered. On the other hand, Japanese Patent Application Laid-Open No. H5-210550 proposes setting, for each file, a period for which the file is protected from deletion so that the file is prevented from being deleted during that period.

It is convenient for the user to be permitted to change the file names and folder names of image files and image folders created by a digital camera to those which the user likes on a personal computer. However, to change a file name or folder name, it is necessary to specify the file (or folder) of which the file (or folder) name is to be changed and then enter the new file (or folder) name, and it is troublesome to perform these operations every time a file name or folder name is changed.

One practiced method of changing file names and folder names more easily is to change only a particular character string included in file names or folder names and collectively change all the file names or folder names that include that particular character string. Even with this method, however, it is still necessary to enter the new string every time a file name or folder name is changed.

On the other hand, there has been developed a software program to be run on a personal computer which permits the head portion of the file names of image files created by a digital camera to the character string specified by the user. Even with this software program, however, it is still necessary to enter a character string every time a file name is changed. Moreover, this software program can deal only with those file names of which the head portion is not set by the user, i.e., those having a predetermined head portion; that is, it does not permit changing those file names of which the head portion has been set by the user of the digital camera or those of which the head portion has been changed on the digital camera.

Furthermore, whereas restrictions are imposed on deletion of files or folders in personal computers, no restrictions are imposed on changing of the file names of image files or the folder names of image folders either in personal computers or in digital cameras. This may cause unintended changes to be made in file names or folder names, resulting in missing image files.

Neither is it customary, after file names or folder names are changed, to record in the image files or image folders their original file names or folder names before the change as information or to leave a file in which is recorded the correspondence between the file names or folder names before the change and those after the change. This makes it troublesome to restore the original file names or folder names of image files or image folders once their names have been changed.

### SUMMARY OF THE INVENTION

An object of the present invention is to provide an image processing apparatus and an image processing program that permit easy renaming of image files and image folders created by an image taking apparatus. Another object of the present invention is to provide an image taking apparatus that permits easy imposition of restrictions on renaming of image files and image folders and on deletion of image files and image folders.

To achieve the above objects, according to one aspect of the present invention, an image processing apparatus for processing an image recorded in an image file is provided with: a reader for reading an image file created by an image taking apparatus; a first receiver for receiving as the file name of the image file a first character string consisting only of characters that are usable on the image taking apparatus; a second receiver for receiving a second character string; a memory for storing the first and second character strings received by the first and second receivers; and a converter for converting, based on the first and second character strings stored in the memory, the first character string included in the file name of the image file into the second character string.

According to another aspect of the present invention, an image processing apparatus for processing an image recorded in an image file is provided with: a reader for reading an image folder that is created by an image taking apparatus to be used to store an image file therein; a first receiver for receiving as the folder name of the image folder a first character string consisting only of characters that are usable on the image taking apparatus; a second receiver for receiving a second character string; a memory for storing the first and second character strings received by the first and second receivers; and a converter for converting, based on the first and second character strings stored in the memory, the first character string included in the folder name of the image folder into the second character string.

These image processing apparatuses permit renaming of an image file or image folder created by an image taking apparatus, and achieves the renaming by replacing the part of the file name or folder name matching the first character string with the second character string. Whereas the first character string consists only of characters that are usable on the image taking apparatus, there are no such restrictions on the second character string; that is, the second character string can include any characters that can be used in a file name or folder name on the image processing apparatus. This makes it possible to change the file name to one that helps to easily recognize the contents of the image file, and to change the folder name to one that helps to easily grasp the relationship among the image files stored in the image folder.

When a file name or folder name consists only of the first character string, the whole file name or folder name is changed; when a file name or folder name includes an extra character or characters in addition to the first character string, part of the file name or folder name is changed. Since the first and second character strings are stored, the user does not need to enter the first and second character strings every time a file name or folder name is changed. Moreover, the user can change all the file names or folder names including the first character string at once.

Advisably, the image processing apparatuses described above are so configured that in the memory are stored a plurality of pairs of mutually corresponding character strings as the first and second character strings, and that the converter converts, based on the plurality of pairs of mutually corresponding character strings stored as the first and second character strings in the memory, the first character string included in the file name of the image file or in the folder name of the image folder into the second character string. This makes it possible to specify more than one character string as the first character string, i.e., as the target of renaming, and thus to change different file names or folder names at once. For example, even when the user of a digital camera sets different character strings as the head portion of file names according to the type of image, by specifying all those character strings as the first character string, it is possible to rename all the image files at once.

Advisably, the image processing apparatuses described above are additionally provided with a third receiver for receiving a third character string, and are so configured that the converter converts the first character string into the second character string only when the third character string received by the third receiver is not included in the file name of the image file or in the folder name of the image folder. This makes it possible to prevent even a file name or folder name including the first character string from being changed when it also includes the third character string, and thereby to protect a particular file name or folder name from being changed.

Advisably, the image processing apparatuses described above are additionally provided with a third receiver for receiving a third character string and a processor for deleting the image file or image folder, and are so configured that the processor is permitted to delete the image file only when the third character string received by the third receiver is not included in the file name of the image file or in the folder name of the image folder. This makes it possible to permit deletion of image files and image folders in general while protecting particular image files and image folders from deletion.

Advisably, the image processing apparatuses described above are additionally provided with a recorder for recording the image file or image folder on a recording medium, and are so configured that the converter further converts, based on the first and second character strings stored in the memory, the second character string included in the file name of the image file or in the folder name of the image folder into the first character string, and that the recorder records information relating to the converter on the recording medium when the converter records on the recording medium the image file or image folder that has the second character string included in the name thereof converted into the first character string.

This makes it possible to convert the second character string back into the first character string, and thereby to restore the original file names or folder names of image files or image folders whose file names or folder names have been changed, or to change the file names or folder names of image files or image folders created by the image processing apparatus itself to those conforming to the image taking apparatus. Moreover, since information relating to the converter is stored, along with the image files or image folders, on the recording medium, when the image files or image folders are read again from the recording medium, it is possible to identify the converter.

According to still another aspect of the present invention, a program product incorporates a program for making a computer execute the steps of: reading an image file created by an image taking apparatus; receiving as the file name of the image file a first character string consisting only of characters that are usable on the image taking apparatus; receiving a second character string; storing the first and second character strings; and converting, based on the first and second character strings stored, the first character string included in the file name of the image file into the second character string.

According to still another aspect of the present invention, a program product comprising a program for making a computer execute the steps of: reading an image folder created by an image taking apparatus; receiving as the folder name of the image folder a first character string consisting only of characters that are usable on the image taking apparatus; receiving a second character string; storing the first and second character strings; and converting, based on the first and second character strings stored, the first character string included in the folder name of the image folder into the second character string.

According to a further aspect of the present invention, an image taking apparatus is provided with: an image generator for generating an image; a file generator for creating an image file in which the image generated by the image generator is recorded; a receiver for receiving as the file name of the image file a character string consisting only of characters usable on the image taking apparatus; and a recorder for recording information with reference to which whether or not to protect the file name of the image file including the character string received by the receiver from being changed is decided.

According to a further aspect of the present invention, an image taking apparatus is provided with: an image generator for generating an image; a folder generator for creating an image folder in which is stored an image file in which is recorded the image generated by the image generator; a receiver for receiving as the folder name of the image folder a character string consisting only of characters usable on the image taking apparatus; and a recorder for recording information with reference to which whether or not to protect the folder name of the image folder including the character string received by the receiver from being changed is decided.

According to a further aspect of the present invention, an image taking apparatus is provided with: an image generator for generating an image; a file generator for creating an image file in which the image generated by the image generator is recorded; a receiver for receiving as the file name of the image file a character string consisting only of characters usable on the image taking apparatus; and a recorder for recording information with reference to which whether or not to protect an image file that has a file name including the character string received by the receiver from being deleted is decided.

According to a further aspect of the present invention, an image taking apparatus is provided with: an image generator for generating an image; a folder generator for creating an image folder in which is stored an image file in which is recorded the image generated by the image generator; a receiver for receiving as the folder name of the image folder a character string consisting only of characters usable on the image taking apparatus; and a recorder for recording information with reference to which whether or not to protect an image folder that has a folder name including the character string received by the receiver from being deleted is decided.

In these image taking apparatuses, it is possible, based on the information recorded by the recorder, to decide whether to protect an image file or image folder from renaming or deletion. This helps to prevent the file name or folder name of a particular image file or image folder from becoming missing, and also helps to prevent an important image file from being lost.

Advisably, the image processing apparatuses described above are so configured that the recorder records the information, with reference to which whether or not to protect the file name or folder name of the image file or image folder from being changed is decided, in a tag of the image file or the image folder. Recording such information in the image file or image folder itself makes management of the information easier. Moreover, when an image file or image folder is fed to the image processing apparatus, the image processing apparatus can, by referring to such information, decide whether to protect an image file or image folder from renaming or deletion.

### BRIEF DESCRIPTION OF THE DRAWINGS

This and other objects and features of the present invention will become clear from the following description, taken in conjunction with the preferred embodiments with reference to the accompanying drawings in which:

FIGS. 1A and 1B are a perspective view and a rear view, respectively, schematically showing a digital camera as an example of an image taking apparatus embodying the invention;

FIG. 2 is a diagram schematically showing the configuration of the digital camera;

FIG. 3 is a diagram showing the folder structure in the digital camera;

FIGS. 4A to 4E are diagrams showing the guide screen that the digital camera displays for the setting of the head portion of the file names of image files;

FIGS. 5A to 5E are diagrams showing the guide screen that the digital camera displays for the setting of the tail portion of the folder names of image folders;

FIG. 6 is a front view schematically showing a personal computer as an example of an image processing apparatus embodying the invention;

FIG. 7 is a diagram schematically showing the configuration of the personal computer;

FIG. 8 is a diagram showing the guide screen that the personal computer displays for the entry of the first and second character strings to be used for the renaming of files;

FIG. 9 is a diagram showing the guide screen that the personal computer displays for the entry of the first and second character strings to be used for the renaming of folders;

FIG. 10 is a diagram showing the guide screen that the personal computer displays for the renaming of image files;

FIG. 11 is a diagram showing the guide screen that the personal computer displays for the renaming of image folders;

FIG. 12A is a diagram showing the guide screen that the personal computer displays after the guide screen shown in FIG. 10 for the renaming of image files;

FIG. 12B is a diagram showing the guide screen that the personal computer displays after the renaming of image files;

FIG. 13A is a diagram showing the guide screen that the personal computer displays after the guide screen shown in FIG. 11 for the renaming of image folders;

FIG. 13B is a diagram showing the guide screen that the personal computer displays after the renaming of image folders;

FIG. 14 is a diagram showing the guide screen that the personal computer displays for the entry of the third character string to be used for the protection of image files from renaming and deletion;

FIG. 15 is a diagram showing the guide screen that the personal computer displays for the entry of the third character string to be used for the protection of image folders from renaming and deletion;

FIG. 16 is a diagram showing the guide screen that the personal computer displays when, with the third character string set, files are about to be renamed;

FIG. 17 is a diagram showing the guide screen that the personal computer displays when, with the third character string set, folders are about to be renamed;

FIG. 18 is a diagram showing the guide screen that the personal computer displays when, with the third character string set, files are about to be deleted;

FIG. 19 is a diagram showing the guide screen that the personal computer displays when, with the third character string set, folders are about to be deleted;

FIG. 20 is a diagram showing the guide screen that the digital camera displays for the entry of the character string to be used for the protection of image files from renaming and deletion;

FIG. 21 is a diagram showing the guide screen that the digital camera displays for the entry of the character string to be used for the protection of image folders from renaming and deletion;

FIG. 22A is a diagram showing an image file as observed when it is protected from renaming and deletion by the digital camera and the corresponding information is fed from the digital camera to the personal computer;

FIG. 22B is a diagram showing the image file shown in FIG. 22A as observed when it is returned from the personal computer to the digital camera after the personal computer once renamed it and later restored its original name;

FIG. 23A is a diagram showing an image folder as observed when it is protected from renaming and deletion by the digital camera and the corresponding information is fed from the digital camera to the personal computer;

FIG. 23B is a diagram showing the image folder shown in FIG. 23A as observed when it is returned from the personal computer to the digital camera after the personal computer once renamed it and later restored its original name;

### DESCRIPTION OF THE PREFERRED EMBODIMENTS

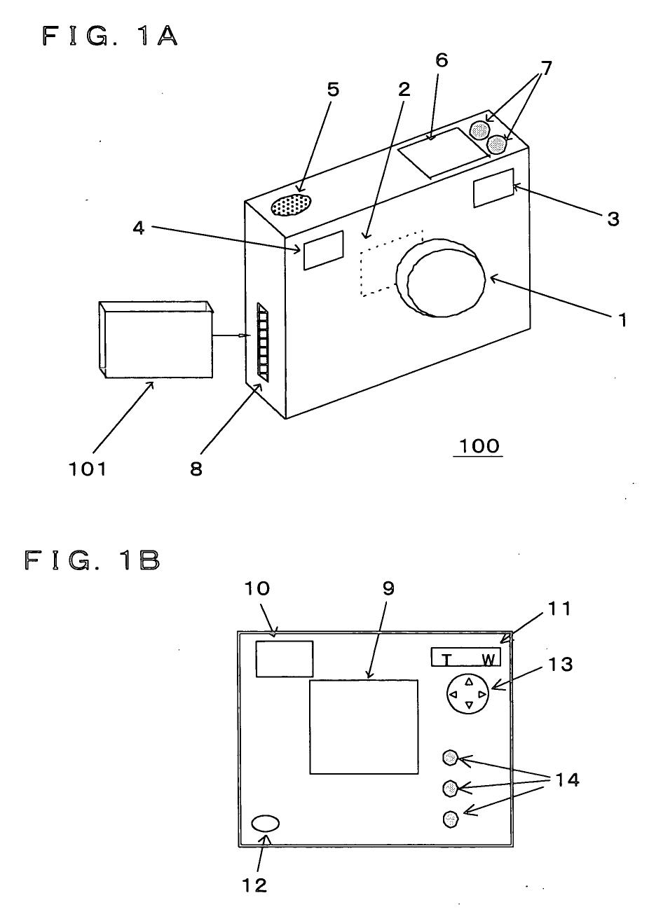

Hereinafter, an embodiment of the present invention will be described with reference to the drawings. FIGS. 1A and 1B show a digital camera 100 as an example of an image taking apparatus embodying the invention. FIGS. 1A and 1B are a perspective view and a rear view, respectively, of the digital camera 100.

On the front face of the digital camera 100, there are provided a taking lens 1, a front viewfinder window 3, and a flash emitter 4. On the top face of the digital camera 100, there are provided a release button 5, a liquid crystal display 6, and two mode setting buttons 7. In a side face of the digital camera 100, there is provided a slot 8 in which to insert a removable recording medium 101. On the rear face of the digital camera 100, there are provided a liquid crystal display 9, a rear viewfinder window 10, a zoom button 11, a loudspeaker 12, a cross button 13, and three operation buttons 14. The digital camera 100 incorporates a CCD area sensor 2, and senses an image by imaging the light from a target subject through the taking lens 1 on the CCD sensor 2 and converting the received light into an electrical signal.

The release button 5, when pressed halfway in, produces an S1 signal that requests automatic exposure control and automatic focus adjustment and, when pressed fully in, produces an S2 signal that requests the starting of the sensing of an image to be recorded and the recording of the sensed image on the recording medium 101. The liquid crystal display 6 displays the current settings of the digital camera 100. The digital camera 100 operates in one of the following two modes: a photographing mode for photographing images and a playback mode for reproducing the images recorded on the recording medium 101. The mode setting buttons 7 are operated to switch between these modes. The photographed images are recorded on the recording medium 101, which is realized with, for example, a slimly designed memory card incorporating a semiconductor memory.

The liquid crystal display 9 displays images and guide screens for guiding the user through different operations. In the photographing mode, images are sensed repeatedly at substantially equal time intervals, and the sensed images are, one after another, immediately displayed on the liquid crystal display 9. The thus displayed image serves as a “live view” that shows the target subject as currently being sensed, and is used, along with the optical image observed through the rear viewfinder window 10, as a reference for framing and zooming. In the playback mode, the images recorded on the recording medium 101 are displayed, one at a time, on the liquid crystal display 9.

The zoom button 11 is operated to set the focal length of the taking lens 1, which is here a zoom lens. The digital camera 100 has a capability of outputting predetermined information by means of sound, and the loudspeaker 12 is used to output such sound.

The cross button 13 has four contacts in total, namely two horizontally arranged (left and right) contacts and two vertically arranged (up and down) contacts, and is operated to cause the cursor (pointer) that appears on the liquid crystal display 9 to move upward, downward, leftward, and rightward. On a guide screen that shows different choices, the user can operate the cross button 13 to move the cursor to the desired choice and thereby select it. In the following descriptions, the different parts of the cross button 13 are also referred to individually as the up, down, left, and right buttons.

The three operation buttons 14 are operated to request a guide screen to be displayed on the liquid crystal display 9, and to finalize a selection made on a guide screen displayed on the liquid crystal display 9. The functions assigned to the three operation buttons 14 vary from one guide screen to another displayed. The functions assigned to the operation buttons 14 are classified roughly into those relating to photographing conditions and those relating to the image files in which the photographed images are recorded and to the image folders in which those image files are stored.

The digital camera 100 creates an image file in a format conforming to the DCF standard, and thus gives the image file a file name consisting of a four-character head portion, which consists only of alphabetic (“A” to “Z”) and underscore (“_”) characters, and a four-character tail portion, which consists only of numeric characters (“0” to “9”). Moreover, the digital camera 100 appends to the end of the file name an extension that indicates the format of the image file. The digital camera 100 also creates an image folder in a format conforming to the DCF standard, and thus gives the image folder a folder name consisting of a three-character head portion, which consists only of numeric characters (“0” to “9”), and a five-character tail portion, which consists only of alphanumeric (“A” to “Z” and “0” to “9”) and underscore (“_”) characters.

The user can set the head portion of the file name, and thus can change it as desired. If the user chooses not to set the head portion, a predetermined character string, for example “PICT,” is used as the head portion. Moreover, the user can rename the image files recorded on the recording medium 101, and can delete the image files recorded on the recording medium 101. Here, it should be noted that the user is permitted to change only the head portion of the file name.

The user can set the tail portion of the folder name, and thus can change it as desired. If the user chooses not to set the tail portion, a predetermined character string, for example “MLT01,” is used as the tail portion. Moreover, the user can rename the image folders recorded on the recording medium 101, and can delete the image folders recorded on the recording medium 101 along with all the image files stored in it. Here, it should be noted that the user is permitted to change only the tail portion of the folder name.

In terms of the functions relating to image files and image folders, the operation buttons 14 each function as one of the following: a “set” button for requesting the finalizing of an entered item, a “file name set” button for requesting the display of a guide screen for the setting of the head portion of the file name, a “folder name set” button for requesting the display of a guide screen for the setting of the tail portion of the folder name, a “rename” button for requesting the renaming of an image file or image folder, a “delete” button for requesting the deletion of an image file or image folder, etc.

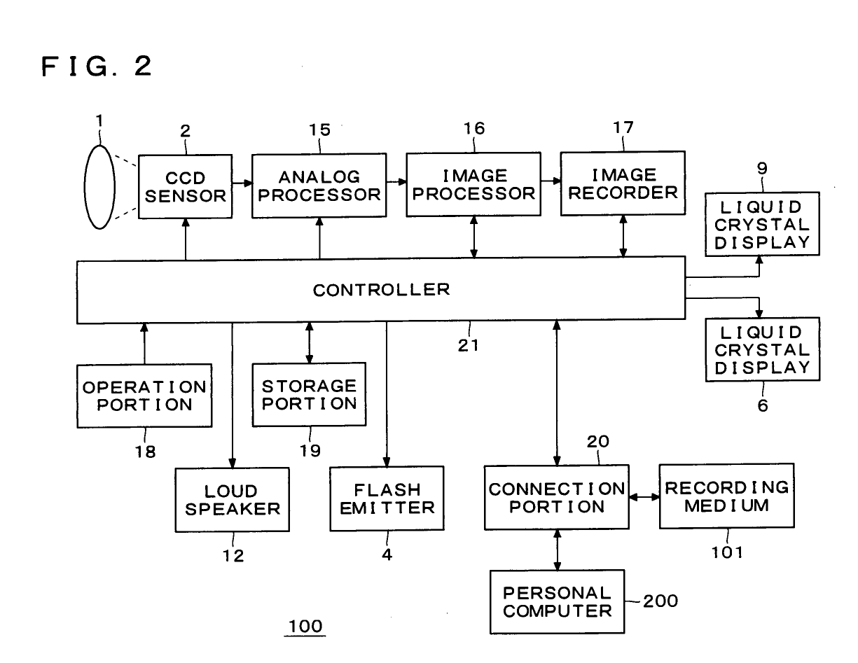

FIG. 2 schematically shows the configuration of the digital camera 100. The digital camera 100 is provided with, in addition to the already mentioned components, an analog processor 15, an image processor 16, an image recorder 17, an operation portion 18, a storage portion 19, a connection portion 20, and a controller 21. The controller 21 incorporates a CPU, and controls the operation of the digital camera 100 as a whole. The functions of the controller 21 include, as well as the photographing and playback of images, the renaming of image files and image folders and the deletion of image files and image folders.

The analog processor 15 performs processing such as gain adjustment on the analog signal outputted from the CCD area sensor 2, and thereby converts the analog signal into a digital signal. The image processor 16 performs processing such as white balance adjustment and gamma correction on the thus obtained digital signal, and thereby produces image data that represents the sensed image. The image recorder 17 temporarily stores the image (image data).

The operation portion 18 accepts the operation by the user, and includes the already mentioned release button 5, zoom button 11, cross button 13, and operation buttons 14. The storage portion 19 has a storage medium such as a flash memory, ROM, or RAM. In the storage portion 19, there are stored programs and parameters that the CPU of the controller 21 uses to achieve the necessary control, and there is also stored information relating to the renaming and deletion of image files.

The connection portion 20 incorporates interfaces to the recording medium 101 and to external equipment, and exchanges data with them. Equipment that can be externally connected to the digital camera 100 by way of the connection portion 20 includes a personal computer 200, which will be described later.

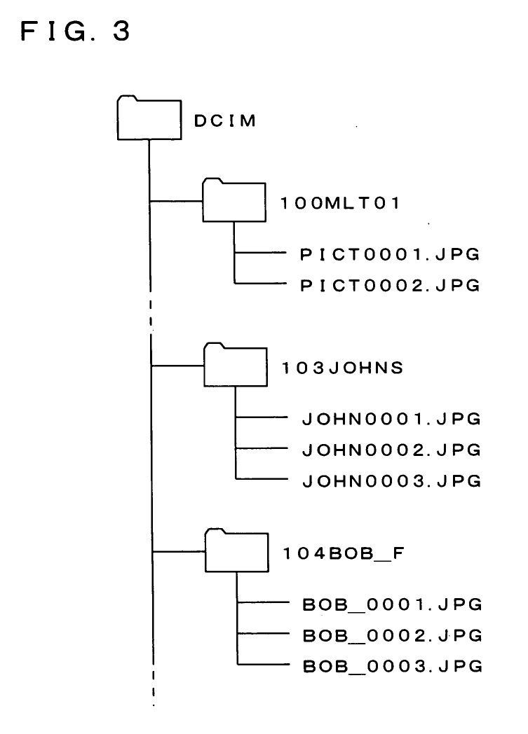

FIG. 3 shows the folder structure in the digital camera 100. At the top level is created a common folder named “DCIM” for storing various folders. In this folder, all the image folders are stored, and, in each of those image folders, individual image files are stored.

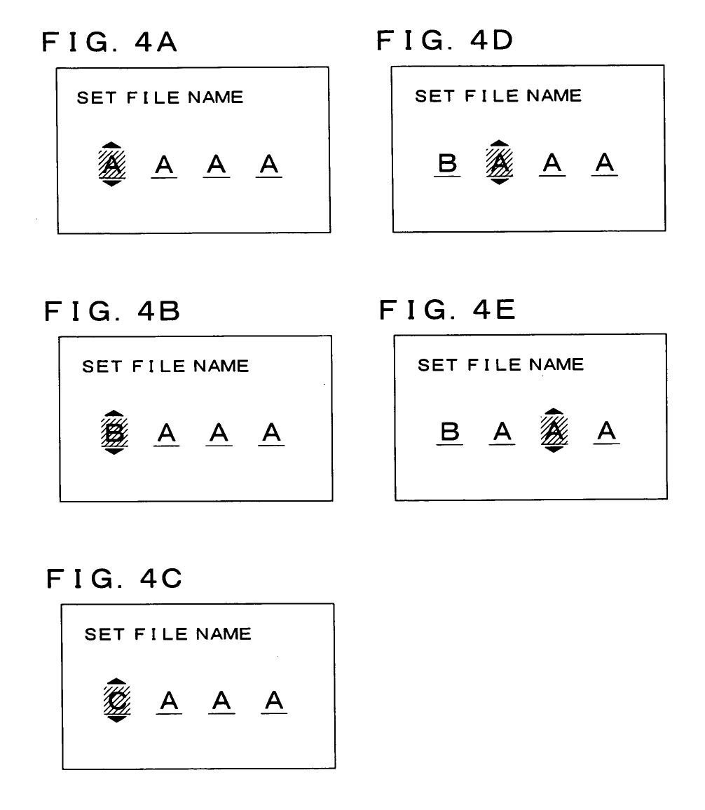

FIGS. 4A to 4E show the guide screen for the setting of the head portion of the file names of image files. In the guide screen, there are shown four areas in which the characters of the head portion are shown one by one. As shown in FIG. 4A, in each of those areas is shown a predetermined character (here “A”), which the user is permitted to change to the desired character. The area in which the user is currently permitted to change the character shown in it is shown in a different mode of display (referred to as “highlighted”; here indicated by hatching) than the other areas, and is accompanied by an upward and a downward triangular symbols above and below it.

Every time the up or down button (i.e., part of the cross button 13) is operated, the character shown in the highlighted area changes from one character to the next as shown in FIGS. 4B and 4C. On the other hand, every time the left or right button is operated, the highlight, which indicates where the user is permitted to change the character shown in it, moves from one area to the next.

The controller 21 gives each image file a file name consisting of the thus set head portion followed by a tail portion consisting of four numerical characters. The user is permitted to set the head portion of the file name at any time. This makes it possible to give image files file names with different head portions according to the type of image. If there already exist any file names of which the head portion is identical with the newly set one, the controller 21 sets the tail portion to be equal to the number greater by one than the greatest among all the numbers set in the tail portion of the existing file names with the identical head portion.

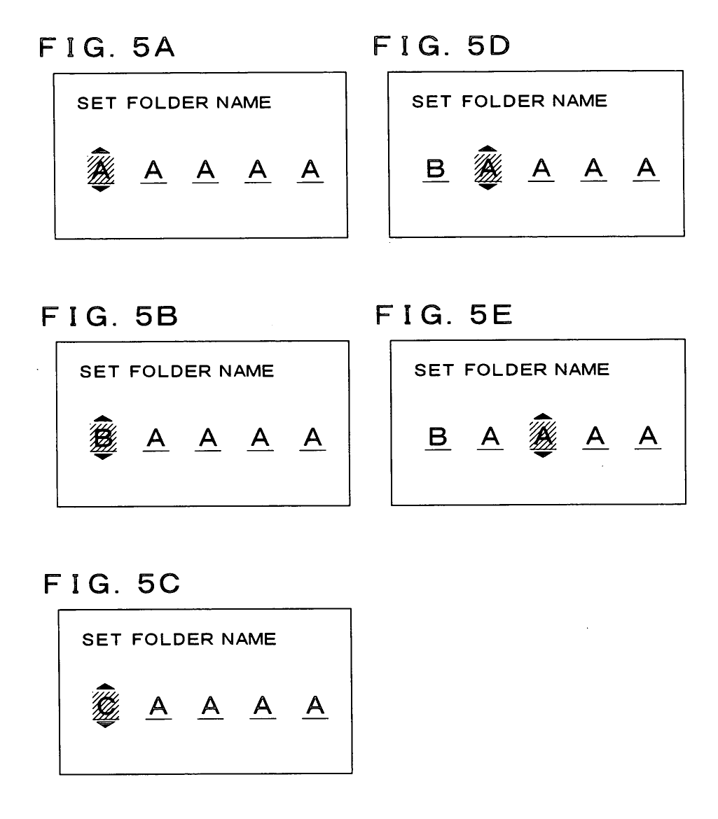

FIGS. 5A to 5E show the guide screen for the setting of the tail portion of the folder names of image folders. This guide screen is the same as the one shown in FIGS. 4A to 4E except in the number of areas in which the characters to be entered are shown, and the user operates on this guide screen in the same manner as on the previously described guide screen.

The controller 21 gives each image folder a folder name consisting of the thus set tail portion preceded by a head portion consisting of three numerical characters. The head portion is set to be equal to the number greater by one than the number set in the head portion of the existing folder name. The image folder of which the folder name is set in this way is thereafter used as the image folder in which to store any newly created image files until another folder name is set. The user is permitted to set the tail portion of the folder name at any time. This makes it possible to set a unique folder name for a particular groups of photographed images so that image files are classified neatly (i.e., stored in different image files).

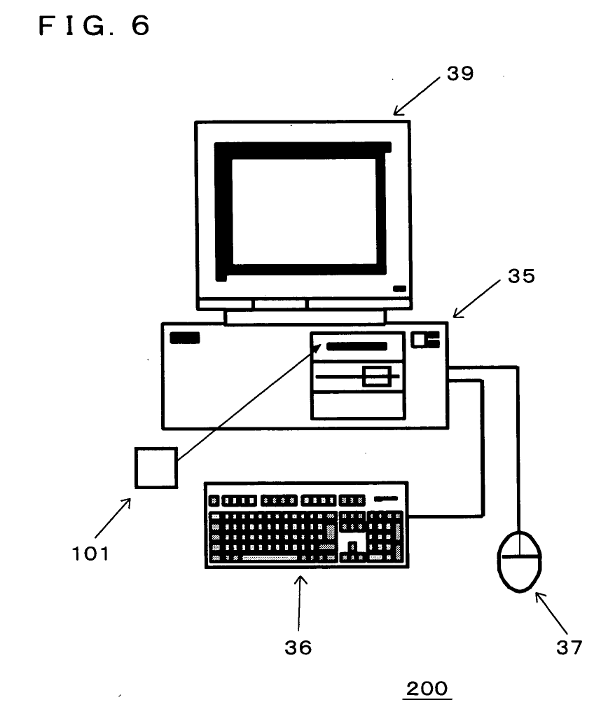

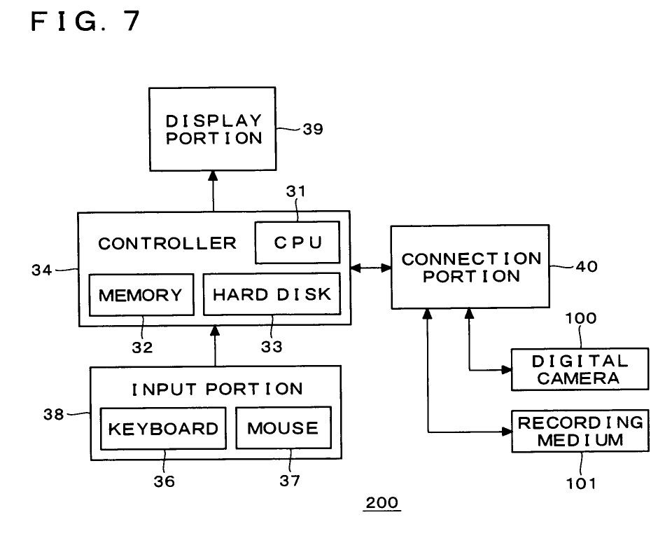

FIG. 6 shows a personal computer 200 as an example of an image processing apparatus embodying the invention, and FIG. 7 shows its configuration. The personal computer 200 is provided with a main unit 35, an input portion 38, and a display portion 39. The main unit 35 incorporates a controller 34 composed of a CPU 31, a memory 32, a hard disk 33, and other components. The input portion 38 includes a keyboard 36, a mouse 37, and the like. The main unit 35 is also provided with a connection portion 40 by way of which an external recording medium such as the aforementioned recording medium 101 or an optical disk can be attached to the main unit 35 and by way of which the main unit 35 can be connected to the digital camera 100 or to the Internet.

The personal computer 200 by itself cannot photograph pictures, but can read image files created by the digital camera 100 from the recording medium 101, or receive such image files directly from the digital camera 100, to reproduce for display or edit the image recorded in those image files. Image files can be read from the recording medium 101 or received from the digital camera 100 either individually on a file-by-file basis or collectively on a folder-by-folder basis.

The personal computer 200 also permits the renaming of any files including image files, the renaming of any folders including image folders, and the deletion of any files and folders. Furthermore, the personal computer 200 permits the recording of image files and image folders on the recording medium 101, and the transmitting of image files and image folders to the digital camera 100. The personal computer 200 even permits images to be created on itself and recorded in image files.

These operations are performed by the CPU 31 of the controller 34 according to the programs recorded in the hard disk 33.

On the personal computer 200, it is possible to give a file a file name consisting of a large number of characters (for example, 256 characters) or one consisting only of one character. In a file name, it is possible to use not only alphabetic (“A” to “Z,” “a” to “z,” and “0” to “9”) and underscore (“_”) characters but also other various symbols and characters. For example, it is possible to use kanji characters (Japanese-adapted Chinese characters). The same laxness with respect to the number and type of usable characters applies to a folder name.

As is commonly practiced, the renaming of files and folders can be done individually on a file-by-file or folder-by-folder basis by specifying a target file or folder and then entering the new file name or folder name. In addition, the personal computer 200 is furnished with a capability of renaming image files and image folders in a special way.

Specifically, a first character string that represents a whole file name or folder name, or part of it, before renaming and a second character string that represents a whole file name or folder name, or part of it, after renaming are previously stored, and, in any file names and folder names that include the first character string, the first character string is replaced with the second character string. Thus, such file names and folder names as consist only of the first character string are changed completely, and such file names and folder names as include an extra character or characters in addition to the first character string are changed partially.

Moreover, in response to a single instruction to rename image files, all the file names that include the first character string are changed at once. Likewise, in response to a single instruction to rename image folders, all the folder names that include the first character string are changed at once. The renaming of image files and the renaming of image folders are done separately.

The first and second character strings are entered through the operation of the keyboard 36 by the user. The entered first and second character strings are stored in the hard disk 33. More than one pair of character strings may be entered as the first and second character strings. In this case, those pairs of mutually corresponding character strings are stored as the first and second character strings in a look-up table (LUT).

Here, the characters that can be used in the first character string are limited to those which can be used in the file name of an image file or in the folder name of an image folder on the digital camera 100. This is to limit the target of renaming using the capability under discussion to, among all types of files handled on the personal computer 200, image files and image folders and thereby prevent other types of files and folders from being unintentionally renamed. On the other hand, no such restrictions are imposed on the characters that can be used in the second character string; that is, in the second character string, it is possible to use any of the characters that can be used in a file name or folder name on the personal computer 200.

With this capability, the user can change the file names of image files created by the digital camera 100 to those which help to easily recognize the contents of the image files, and the user can change the folder name of an image folder created by the digital camera 100 to one that helps to easily grasp the relationship among the group of image files stored in the image folder. In this way, the user can process images on the personal computer 200 with increased efficiency.

The above described capability relating to the renaming of image files and image folders includes a function of replacing the second character string included in file names or folder names with the first character string. With this function, it is easy to restore the original file names or folder names of image files or image folders after their names have been changed. Moreover, it is possible to use on the digital camera 100 image files that the personal computer 200 has created in a format compatible with the digital camera 100. The purpose of limiting the characters that can be used in the first character string to those which can be used on the digital camera 100 is to permit image files or image folders for which the second character string included in their names is replaced with the first character string to be handled intact on the digital camera 100.

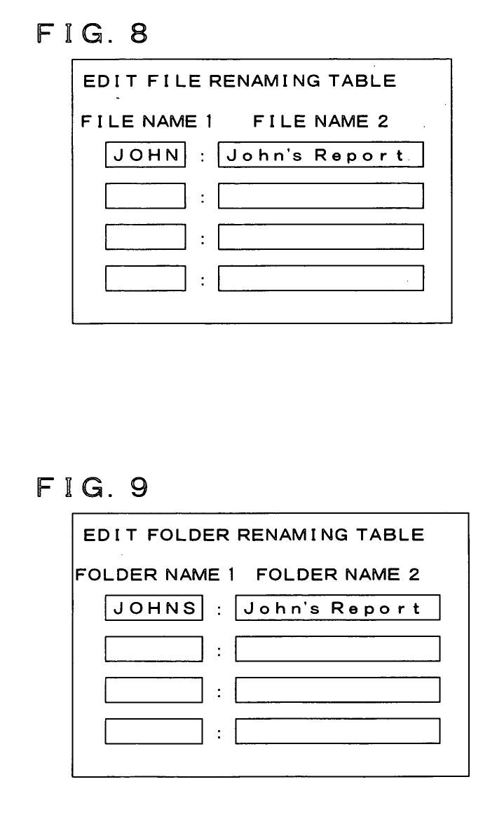

FIGS. 8 and 9 show the guide screens for the entry of the first and second character strings. Whereas the guide screen shown in FIG. 8 is for the entry of a character string to be used for the renaming of files, the guide screen shown in FIG. 9 is for the entry of a character string to be used for the renaming of folders.

Under the heading “File Name 1” or “Folder Name 1,” there are shown text boxes in which to enter character strings as the first character string; under the heading “File Name 2” or “Folder Name 2,” there are shown text boxes in which to enter character strings as the second character string. Moreover, between a text box for the first character string and the corresponding text box for the second character string is shown a colon (“:”) to indicate the correspondence between them. The user selects one of the text boxes as the target of character string entry by operating the cursor keys on the keyboard 36 or by operating the mouse 37. The characters entered via the keyboard 36 then sequentially appear in that text box. When the enter key is operated, the entry of the character string in this text box is finalized, and the target of character string entry moves to the next text box. The text boxes for the entry of the second character string scroll horizontally when a long character string is entered.

The controller 34 checks whether or not the characters entered in a text box for the first character string are those which can be used on the digital camera 100, and checks whether or not the characters entered in a text box for the second character string are those which can be used on the personal computer 200. The controller 34 rejects any characters that are not permitted in the respective character strings. The controller 34 also performs character conversion appropriate for the language handled on the characters that are entered as the second character string.

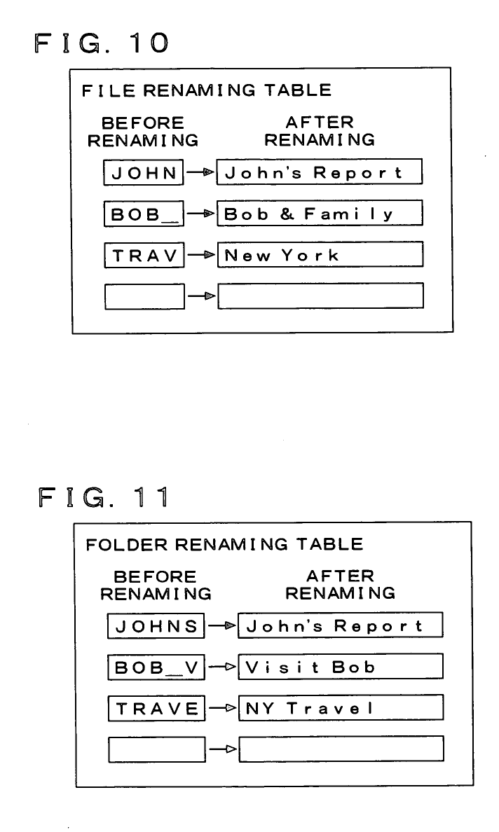

FIGS. 10 and 11 show examples of the guide screens that the personal computer 200 displays on the display portion 39 for the renaming of image files and image folders by the use of the capability described above. On these guide screens, all the pairs of mutually corresponding character strings previously entered as the first and second character strings are shown. Moreover, to indicate which of the first and second character strings is the one included in file names before renaming and which the one included in file names after renaming, there are also shown headings “Before Renaming” and “After Renaming” along with arrows. In both of the examples shown in FIGS. 10 and 11, three pairs of character strings have previously been entered as the first and second character strings, and the first character string is going to be replaced with the second character string.

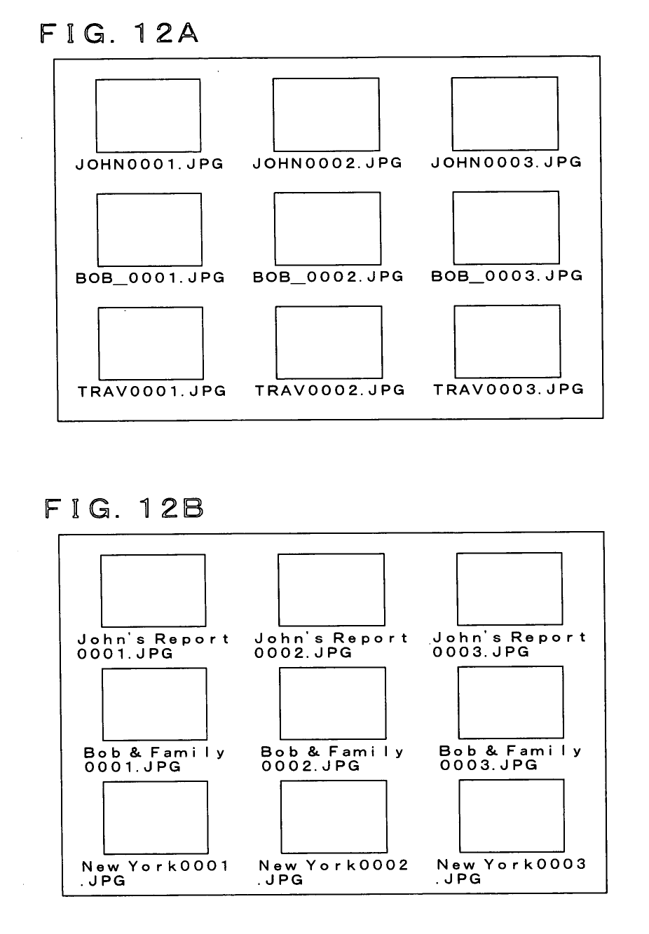

While a guide screen as shown in FIG. 10 is displayed, when an instruction is received to proceed with the renaming of files, the thumbnail images of all the images recorded in the image files that are going to be renamed are shown in a neatly arranged manner together with their file names. FIG. 12A shows an example of the screen at this time. In this example, there exist nine image files in total of which the file name includes “JOHN,” “BOB_,” or “TRAV” as the head portion and “0001,” “0002,” or “0003” as the tail portion.

While a guide screen as shown in FIG. 12A is displayed, when an instruction is received to further proceed with the renaming of files, the renaming of the relevant files is executed, and the files names currently being shown on the screen are changed to new file names. FIG. 12B shows an example of the screen at this time. In this example, according to the correspondence shown in FIG. 10, the head portion of the file names, namely “JOHN,” “BOB_,” or “TRAV,” is replaced with “John's Report,” “Bob & Family,” or “New York,” respectively.

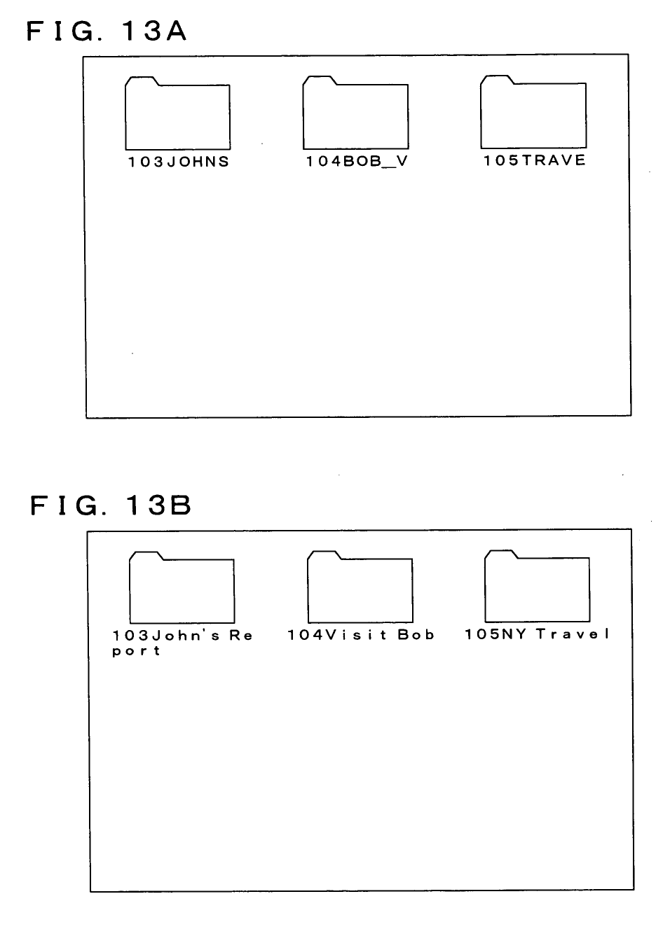

While a guide screen as shown in FIG. 11 is displayed, when an instruction is received to proceed with the renaming of folders, the icons of all the image folders that are going to be renamed are shown in a neatly arranged manner together with their folder names. FIG. 13A shows an example of the screen at this time. In this example, there exist three image folders of which the folder name includes “JOHNS,” “BOB_V,” or “TRAVE” as the tail portion.

While a guide screen as shown in FIG. 13A is displayed, when an instruction is received to further proceed with the renaming of folders, the renaming of the relevant folders is executed, and the folder names currently being shown on the screen are changed to new folder names. FIG. 13B shows an example of the screen at this time. In this example, according to the correspondence shown in FIG. 11, the tail portion of the folder names, namely “JOHNS,” “BOB_V,” or “TRAVE,” is replaced with “John's Report,” “Visit Bob,” or “NY Travel,” respectively.

The renaming of image files or image folders in a case where the second character string is replaced with the first character string is performed through similar guide screens. In that case, however, the headings “Before Renaming” and “After Renaming” are show in the reverse order, with the arrows all pointing in the reverse direction.

More than one look-up table may be prepared each listing a different pattern of correspondence between the first and second character strings. This makes it possible to record in different look-up tables different sets of pairs of mutually corresponding character strings such that all sets include the same character strings as the first character string but different character strings as the second character string. This makes it possible to change a given single file name to one of different new file names. In a case where more than one look-up table is prepared in this way, each look-up table is given a unique name to permit the user to select which look-up table to use on the guide screen for the renaming of files or folders.

The personal computer 200 has a capability of protecting image files and image folders from renaming. It also has a capability of protecting image files and image folders from deletion. These capabilities are achieved in the following manner. A third character string is previously entered and stored, and, in response to an instruction to rename or delete image files or image folders, whether or not the file names or folder names of the specified image files or image folders include the third character string is checked so that, if so, the requested renaming or deletion of image files or image folders is not executed.

The above capability relating to the renaming of file names and folder names works not only when file names or folder names are changed individually but also when the first character string is replaced with the second character string or when the second character string is replaced with the first character string as described earlier. Accordingly, by entering as the third character string a character string that includes an extra character string in addition to the first character string, it is possible to change only particular ones among all the file names or folder names that include the first character string. For example, in the example shown in FIGS. 10 and 12, if the character string “JOHN0003” has previously been entered as the third character string, it is possible to change eight file names excluding “JOHN0003.JPG.”

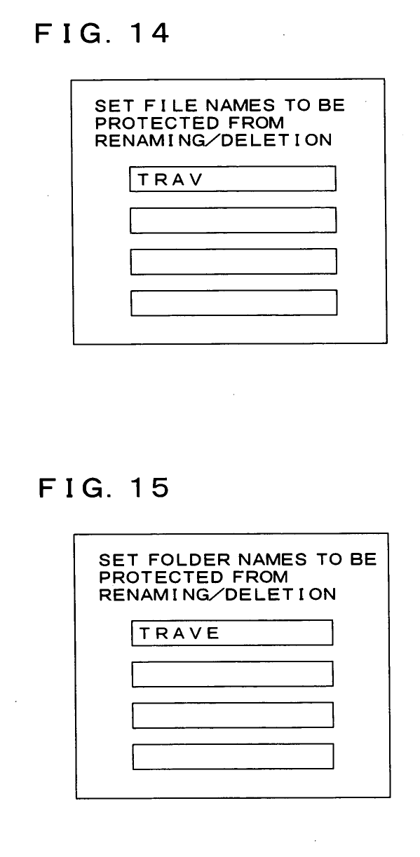

FIGS. 14 and 15 show the guide screens for the entry of the third character string. FIG. 14 is the guide screen for image files, and FIG. 15 is the guide screen for image folders. More than one character string can be entered as the third character string, and accordingly several text boxes are shown on the guide screen. The user selects one of the text boxes as the target of character string entry by operating the cursor keys on the keyboard 36 or by operating the mouse 37. The characters entered via the keyboard 36 then sequentially appear in that text box. When the enter key is operated, the entry of the character string in this text box is finalized, and the target of character string entry moves to the next text box.

In the example shown in FIG. 14, all the image files of which the names include the character string “TRAV” is protected from renaming and deletion. In the example shown in FIG. 15, all the image folders of which the names include the character string “TRAVE” is protected from renaming and deletion.

In the third character string, it is possible to use any of the characters that can be used on the personal computer 200. This makes it possible to protect particular file names or folder names from being changed not only when the first character string is replaced with the second character string but also when the second character string is replaced with the first character string. The third character string also is stored in the hard disk 33.

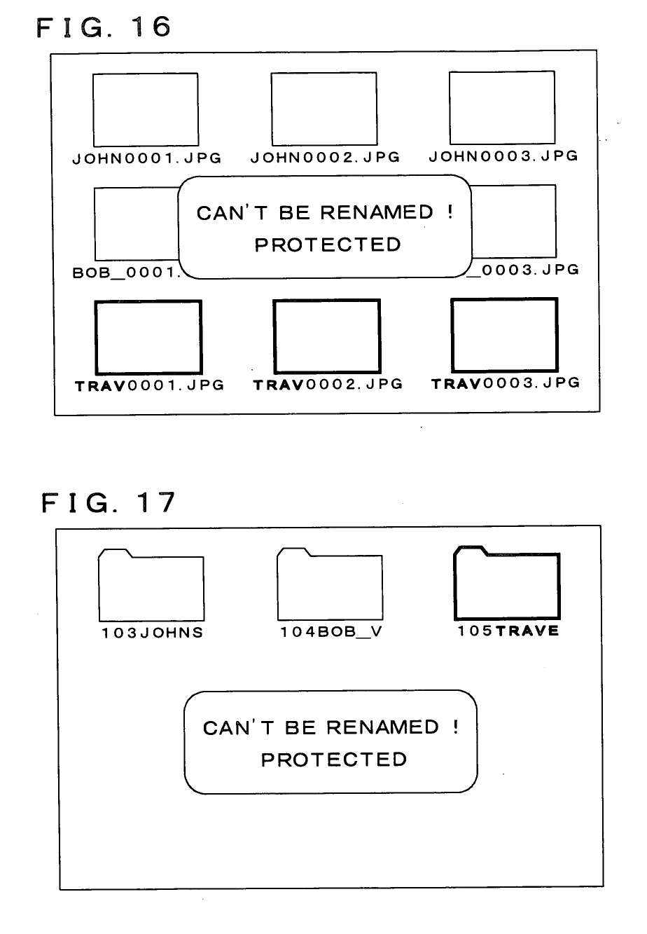

FIG. 16 shows an example of the guide screen displayed for the renaming of image files when the third character string is set. This example deals with a case where, with the character string “TRAV” set as the third character string as shown in FIG. 14, the user has attempted to proceed with the renaming of image files from the state shown in FIG. 12A.

As shown in the figure, if any of the file names that the user has attempted to change includes the third character string, a message is shown to indicate that the specified file names include one or some that are protected from being changed. Moreover, the thumbnail images of the image files having the relevant file names are shown in a different mode of display than the other thumbnail images, and the third character string included in those files names is shown in different mode of display than the other file names. In the example being described, the different modes of display are realized by showing the relevant thumbnail images in a frame and showing the relevant characters in bold type. Sound may be outputted to indicate the inclusion of a file name that is protected from being changed.

While a guide screen as described above is displayed, when an instruction is received to further proceed with the renaming of files, among the specified file names, those which do not include the third character string are changed, and, as shown in FIG. 12B, the files names currently being shown on the screen are changed to new file names. Here, however, those file names which have remained unchanged and the thumbnail images of the image files having those file names are no longer shown on the screen.

FIG. 17 shows an example of the guide screen displayed for the renaming of image folders when the third character string is set. This example deals with a case where, with the character string “TRAVE” set as the third character string as shown in FIG. 15, the user has attempted to proceed with the renaming of image folders from the state shown in FIG. 13A.

As shown in the figure, if any of the folder names that the user has attempted to change includes the third character string, a message is shown to indicate that the specified folder names include one or some that are protected from being changed. Moreover, the icons of the image folders having the relevant folder names are shown in a different mode of display than the icons of the other image folders, and the third character string included in those folder names is shown in different mode of display than the other folder names. In the example being described, the different modes of display are realized by showing the icons of the relevant image folders with a differently colored outline and showing the relevant characters in bold type.

While a guide screen as described above is displayed, when an instruction is received to further proceed with the renaming of folders, among the specified folder names, those which do not include the third character string are changed, and, as shown in FIG. 13B, the folder names currently being shown on the screen are changed to new folder names. Here, however, those folder names which have remained unchanged and the icons of the image folders having those folder names are no longer shown on the screen.

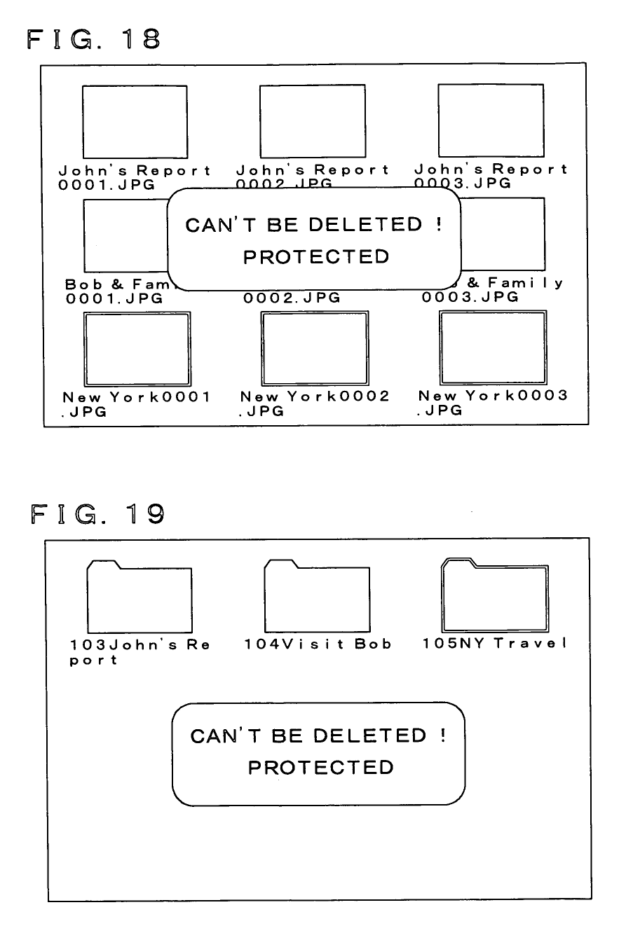

FIG. 18 shows an example of the guide screen displayed for the deletion of image files when the third character string is set. This example deals with a case where the character string “New York” is set as the third character string. In the guide screen for the deletion of image files, the thumbnail images of the images recorded in all the image files specified by the user are shown in a neatly arranged manner along with their file names. Here, if any of the specified image files has a file name including the third character string, a message is shown to indicate that the specified image files include one or some that are protected from deletion. Moreover, the thumbnail images of those image files are shown in a different mode of display than the other thumbnail images. As in the case of the renaming of files, the third character string included in those file names may be shown in a different mode of display than the other file names.

While a guide screen as described above is displayed, when an instruction is received to proceed further with the deletion of image files, those image files of which the file name does not include the third character string are deleted.

FIG. 19 shows an example of the guide screen displayed for the deletion of image folders when the third character string is set. This example deals with a case where the character string “NY Travel” is set as the third character string. In the guide screen for the deletion of image folders, the icons of all the image folders specified by the user are shown in a neatly arranged manner along with their folder names. Here, if any of the specified image folders has a folder name including the third character string, a message is shown to indicate that the specified image folders include one or some that are protected from deletion. Moreover, the icons of those image folders are shown in a different mode of display than the icons of the other image folders. As in the case of the renaming of folders, the third character string included in those folder names may be shown in a different mode of display than the other folder names.

While a guide screen as described above is displayed, when an instruction is received to proceed further with the deletion of image folders, those image folders of which the folder name does not include the third character string are deleted.

In a case where the third character string is so set that all image files are protected from renaming and deletion, it is possible to totally dispense with the displaying of the guide screens for the renaming and deletion of image files so that no such operation itself can be performed at all. The same applies to the renaming and deletion of image folders.

Such protection of image files and image folders from renaming and deletion depending on whether their names include a particular character string or not may be applied to the digital camera 100. In that case, with image files, the head portion of their file names corresponds to a character string, which is thus limited to four characters; with image folders, the tail portion of their folder names corresponds to a character string, which is thus limited to five characters. Moreover, these character strings are permitted to include only those which can be used on the digital camera 100.

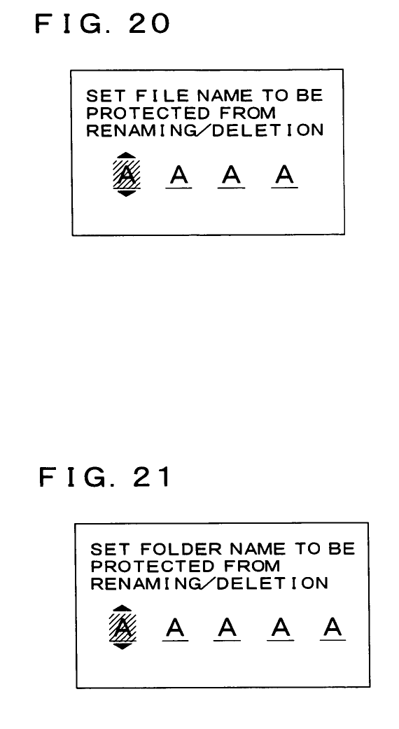

FIGS. 20 and 21 show the guide screens for the entry of such character strings on the digital camera 100. FIG. 20 is the guide screen for file names, and FIG. 21 is the guide screen for folder names. These guide screens are similar to those for the setting of the head portion of file names and the tail portion of folder names (FIGS. 4A to 4E and 5A to 5E), and permit the entry of a character string, or more than one character string, through similar operations.

Information on the protection, set on the digital camera 100, of image files and image folders from renaming and deletion may be fed to the personal computer 200 so that the information is used to protect, on the personal computer 200, image files and image folders from renaming and deletion.

In that case, with image files, the digital camera 100 records in the tag (header) of each image file information as to whether it is protected from renaming and deletion or not, and the personal computer 200 stored the information intact so that, when instructed to rename or delete that image file, the personal computer 200 refers to its tag to check whether it is protected from renaming and deletion or not. Likewise, with image folders, the digital camera 100 records in the tag of each image folder information as to whether it is protected from renaming and deletion or not, and the personal computer 200 stores the information intact so that, when instructed to rename or delete that image folder, the personal computer 200 refers to its tag to check whether it is protected from renaming and deletion or not.

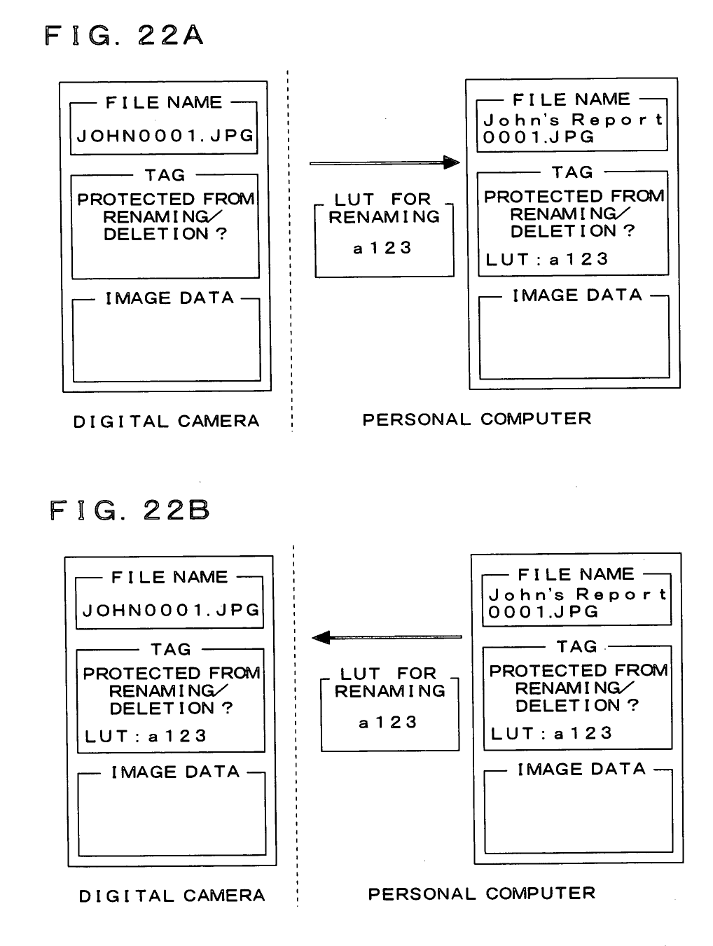

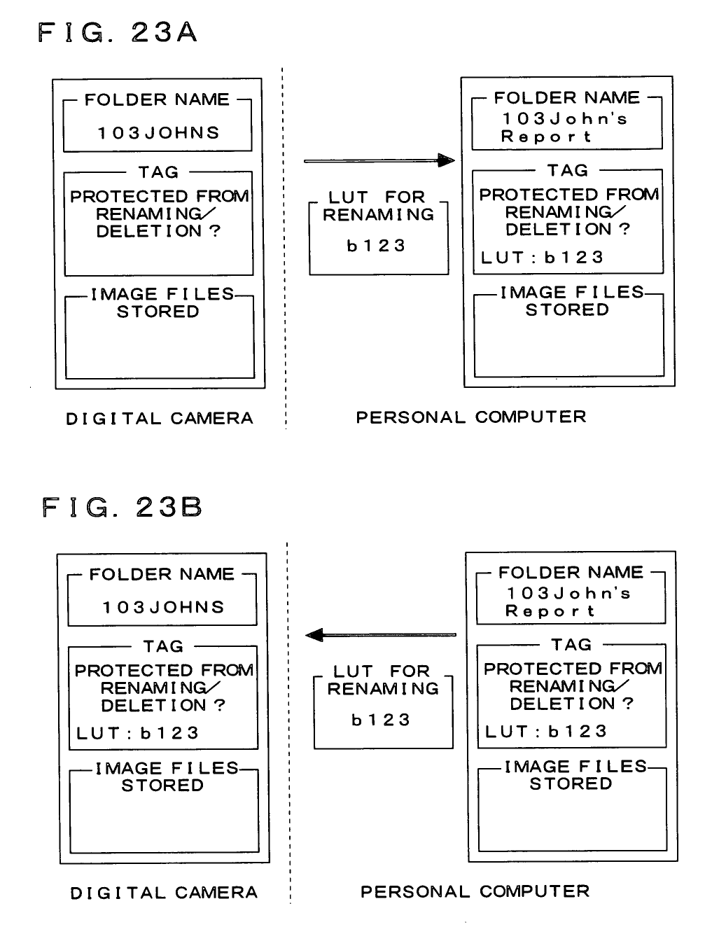

FIG. 22A shows how an image file is handled in such a case, and FIG. 23A shows how an image folder is handled in such a case.

The personal computer 200, when it uses its capability described earlier of renaming file names or folder names by using the first and second character strings, records in the tag of the thus renamed image files or image folder the name of the look-up table used to rename them. In FIG. 22A, the personal computer 200 renames image files by using a look-up table named “a123”; in FIG. 23A, the personal computer 200 renames image folders by using a look-up table named “b123.”

Conversely, when an image file having information as to whether it is protected from renaming and deletion or not recorded in its tag is fed from the personal computer 200 to the digital camera 100, the digital camera 100 stores the information intact. Likewise, when an image folder having information as to whether it is protected from renaming and deletion or not recorded in its tag is fed from the personal computer 200 to the digital camera 100, the digital camera 100 stores the information intact.

Moreover, if the name of a look-up table is recorded in the tag, the digital camera 100 also stores it intact. FIGS. 22B and 23B show how this proceeds. By storing the name of a look-up table intact, even when the same image files or image folders are transmitted again from the digital camera 100 to the personal computer 200, or are recorded in the recording medium 101 and then fed to the personal computer 200, the personal computer 200 can perform the renaming of those image files or image folders by using the same look-up table that it used before.

When image files are protected from renaming and deletion on the digital camera 100, instead of recording in the tag of the image files information indicating that they are protected from renaming and deletion, it is also possible to record in their tag the character string that was used to recognize their being protected from renaming and deletion. The same applies also to image folders. This makes it possible for the personal computer 200 to use that character string as the third character string and thereby protect a larger number of image files and image folders.

For example, when the personal computer 200 has previously obtained from the digital camera 100 image files of which the file name includes such a character string, and thereafter image files of which the file name includes that character string are protected from renaming and deletion on the digital camera 100, then it is possible also to protect the image files that have previously been obtained from renaming and deletion.

In a digital camera of a different type from the digital camera 100, the user is not permitted to set the head portion of the file names of image files or the tail portion of the folder names of image folders, and instead fixed character strings are used as the head and tail portions. When handling image files and image folders created by such a digital camera, there is less sense in replacing the first character string included in file names or folder names with the second character string.

In that case, it is advisable to handle image files and image folders in the following manner. On the digital camera, the character strings entered by the user through the procedure shown in FIGS. 4A to 4E and FIGS. 5A to 5E are recorded in the tag of image files or image folders. This makes it possible to distinguish image files having the identical head portion in their file names according to their contents, and to distinguish image folders having the identical tail portion in their folder names according to the relationship among the image files stored in them. On the personal computer, whether the character strings recorded in the tag of the image files or image folders obtained from the digital camera match the first character string or not is checked and, if so, the head portion of file names or the tail portion of folder names is replaced with the second character string.

By this method, only the head portion of file names or the tail portion of folder names is changed. Thus, as compared with the method described earlier whereby the first character string included in file names or folder names is replaced with the second character string, this method offers less flexibility in renaming files and folders, but even then permits the renaming of only part of the existing image files or image folders. Moreover, with image files or image folders having the identical character string recorded in their tag, it is possible to rename them all at once.

Obviously, many modifications and variations of the present invention are possible in light of the above teachings. It is therefore to be understood that within the scope of the appended claims, the invention may be practiced other than as specifically described.

1. An image processing apparatus for processing an image recorded in an image file, the image processing apparatus comprising:
a reader for reading an image file created by an image taking apparatus;
a first receiver for receiving as a file name of the image file a first character string consisting only of characters that are usable on the image taking apparatus;
a second receiver for receiving a second character string;
a memory for storing the first and second character strings received by the first and second receivers; and
a converter for converting, based on the first and second character strings stored in the memory, the first character string included in the file name of the image file into the second character string.

2. An image processing apparatus as claimed in claim 1,
wherein in the memory are stored a plurality of pairs of mutually corresponding character strings as the first and second character strings, and
wherein the converter converts, based on the plurality of pairs of mutually corresponding character strings stored as the first and second character strings in the memory, the first character string included in the file name of the image file into the second character string.

3. An image processing apparatus as claimed in claim 1, further comprising:
a third receiver for receiving a third character string,
wherein the converter converts the first character string into the second character string only when the third character string received by the third receiver is not included in the file name of the image file.

4. An image processing apparatus as claimed in claim 1, further comprising:
a third receiver for receiving a third character string; and
a processor for deleting the image file,
wherein the processor is permitted to delete the image file only when the third character string received by the third receiver is not included in the file name of the image file.

5. An image processing apparatus as claimed in claim 1, further comprising:
a recorder for recording the image file on a recording medium,
wherein the converter further converts, based on the first and second character strings stored in the memory, the second character string included in the file name of the image file into the first character string, and
wherein the recorder records information relating to the converter on the recording medium when the converter records on the recording medium the image file that has the second character string included in the file name thereof converted into the first character string.

6. An image processing apparatus for processing an image recorded in an image file, the image processing apparatus comprising:
a reader for reading an image folder that is created by an image taking apparatus to be used to store an image file therein;
a first receiver for receiving as a folder name of the image folder a first character string consisting only of characters that are usable on the image taking apparatus;
a second receiver for receiving a second character string;
a memory for storing the first and second character strings received by the first and second receivers; and
a converter for converting, based on the first and second character strings stored in the memory, the first character string included in the folder name of the image folder into the second character string.

7. An image processing apparatus as claimed in claim 6,
wherein in the memory are stored a plurality of pairs of mutually corresponding character strings as the first and second character strings, and
wherein the converter converts, based on the plurality of pairs of mutually corresponding character strings stored as the first and second character strings in the memory, the first character string included in the folder name of the image folder into the second character string.

8. An image processing apparatus as claimed in claim 6, further comprising:
a third receiver for receiving a third character string,
wherein the converter converts the first character string into the second character string only when the third character string received by the third receiver is not included in the folder name of the image folder.

9. An image processing apparatus as claimed in claim 6, further comprising:
a third receiver for receiving a third character string; and
a processor for deleting the image folder,
wherein the processor is permitted to delete the image folder only when the third character string received by the third receiver is not included in the folder name of the image folder.

10. An image processing apparatus as claimed in claim 6, further comprising:
a recorder for recording the image folder on a recording medium,
wherein the converter further converts, based on the first and second character strings stored in the memory, the second character string included in the folder name of the image folder into the first character string, and
wherein the recorder records information relating to the converter on the recording medium when the converter records on the recording medium the image folder that has the second character string included in the folder name thereof converted into the first character string.

11. A program product comprising a program for making a computer execute the steps of:
reading an image file created by an image taking apparatus;
receiving as a file name of the image file a first character string consisting only of characters that are usable on the image taking apparatus;
receiving a second character string;
storing the first and second character strings; and
converting, based on the first and second character strings stored, the first character string included in the file name of the image file into the second character string.

12. A program product comprising a program for making a computer execute the steps of:
reading an image folder created by an image taking apparatus;
receiving as a folder name of the image folder a first character string consisting only of characters that are usable on the image taking apparatus;
receiving a second character string;
storing the first and second character strings; and
converting, based on the first and second character strings stored, the first character string included in the folder name of the image folder into the second character string.

13. An image taking apparatus comprising:
an image generator for generating an image;
a file generator for creating an image file in which the image generated by the image generator is recorded;
a receiver for receiving as a file name of the image file a character string consisting only of characters usable on the image taking apparatus; and
a recorder for recording information with reference to which whether or not to protect the file name of the image file including the character string received by the receiver from being changed is decided.

14. An image taking apparatus as claimed in claim 13,
wherein the recorder records the information in a tag of the image file.

15. An image taking apparatus comprising:
an image generator for generating an image;
a folder generator for creating an image folder in which is stored an image file in which is recorded the image generated by the image generator;
a receiver for receiving as a folder name of the image folder a character string consisting only of characters usable on the image taking apparatus; and
a recorder for recording information with reference to which whether or not to protect the folder name of the image folder including the character string received by the receiver from being changed is decided.

16. An image taking apparatus as claimed in claim 15,
wherein the recorder records the information in a tag of the image folder.

17. An image taking apparatus comprising:
an image generator for generating an image;
a file generator for creating an image file in which the image generated by the image generator is recorded;
a receiver for receiving as a file name of the image file a character string consisting only of characters usable on the image taking apparatus; and
a recorder for recording information with reference to which whether or not to protect an image file that has a file name including the character string received by the receiver from being deleted is decided.

18. An image taking apparatus as claimed in claim 17,
wherein the recorder records the information in a tag of the image file.

19. An image taking apparatus comprising:
an image generator for generating an image;
a folder generator for creating an image folder in which is stored an image file in which is recorded the image generated by the image generator;
a receiver for receiving as a folder name of the image folder a character string consisting only of characters usable on the image taking apparatus; and
a recorder for recording information with reference to which whether or not to protect an image folder that has a folder name including the character string received by the receiver from being deleted is decided.

20. An image taking apparatus as claimed in claim 19,
wherein the recorder records the information in a tag of the image folder.
